(19) United States
(12) Patent Application Publication
(10) Pub. No.: US 2024/0342951 A1
(43) Pub. Date: Oct. 17, 2024

(54) Concrete Cap Molding Device And Method Of Use

(71) Applicant: Lachlan Kent, Koongal (AU)

(72) Inventor: Lachlan Kent, Koongal (AU)

(21) Appl. No.: 18/133,331

(22) Filed: Apr. 11, 2023

(51) Int. Cl. B28B 1/20; B28B 7/00

(52) U.S. Cl. CPC B28B 1/20; B28B 7/0061

(57) ABSTRACT

A concrete cap molding device for molding concrete caps for posts includes a clamshell mold, which is selectively hingable between open and closed configurations. In the closed configuration, the clamshell mold has a top, in which an orifice is centrally positioned, a bottom, which is open, a sidewall extending between the top and the bottom, and a circular cross-sectional profile when viewed from the bottom or the top. Handles are attached to the clamshell mold and can be grasped in hands of a user, enabling the user to position the clamshell mold around a post that protrudes from a mound of concrete, to close the clamshell mold, and to rotate or oscillate the clamshell mold, concurrently with motivating the clamshell mold into the mound of concrete to mold the mound of concrete into a concrete cap around the post.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to concrete molds and more particularly pertains to a new concrete mold for molding concrete caps for posts. The present invention discloses a concrete mold enabling a user to readily and reproducibly generate concrete caps around posts, such as required when fencing is being installed.

### (2) Description of Related Art Including Information Disclosed Under 37 CFR 1.97 and 1.98

The prior art relates to concrete molds, which may comprise selectively extensible tube molds. Related prior art comprises concrete foundation caps. The prior art does not teach concrete mold comprising a clamshell mold for creating concrete caps around posts.

### (h) BRIEF SUMMARY OF THE INVENTION

An embodiment of the disclosure meets the needs presented above by generally comprising a clamshell mold, which is selectively hingable between an open configuration and a closed configuration. The clamshell mold in the closed configuration comprises a top and defines an orifice in the top, which is circular and centrally positioned. A bottom of the clamshell mold is open. The clamshell mold has a circular cross-sectional profile when viewed from the bottom or the top. A sidewall extends between the top and the bottom. A plurality of handles is attached to a pair of elements that define the clamshell mold so that each element is fitted with at least one handle. Respective handles are configured to be grasped in hands of a user, enabling the user to position the clamshell mold around a post that protrudes from a mound of concrete, to close the clamshell mold, and to rotate or oscillate the clamshell mold, concurrently with motivating the clamshell mold into the mound of concrete, to mold the mound of concrete into a concrete cap around the post.

Another embodiment of the disclosure includes a method of molding a concrete cap. Steps of the method include hinging a clamshell mold to an open configuration, positioning the clamshell mold around a post protruding from a mound of concrete, hinging a clamshell mold to a closed configuration, and rotating or oscillating the clamshell mold concurrently with motivating the clamshell mold into the mound of concrete so that the mound of concrete enters the clamshell mold from a bottom of the clamshell mold, the bottom is open. Additional steps of the method may include hinging the clamshell mold to the open configuration, lifting the clamshell mold from the concrete cap and evaluating the concrete cap for voids, adding additional concrete to any voids, as necessary, hinging the clamshell mold to the closed configuration, and rotating or oscillating the clamshell mold concurrently with motivating the clamshell mold into the mound of concrete. The previous four steps can be repeated, as necessary, to obtain a concrete cap that is free of voids.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a concrete cap molding device according to an embodiment of the disclosure.

FIG. 2 is an isometric perspective view of an embodiment of the disclosure.

FIG. 3 is a front view of an embodiment of the disclosure.

FIG. 4 is a side view of an embodiment of the disclosure.

FIG. 5 is a top view of an embodiment of the disclosure.

FIG. 6 is a bottom view of an embodiment of the disclosure.

FIG. 7 is an in-use view of an embodiment of the disclosure.

FIG. 8 is an in-use view of an embodiment of the disclosure.

FIG. 9 is a concrete cap produced using an embodiment of the disclosure.

FIG. 10 is a flow diagram for a method utilizing an embodiment of the disclosure.

### (j) DETAILED DESCRIPTION OF THE INVENTION

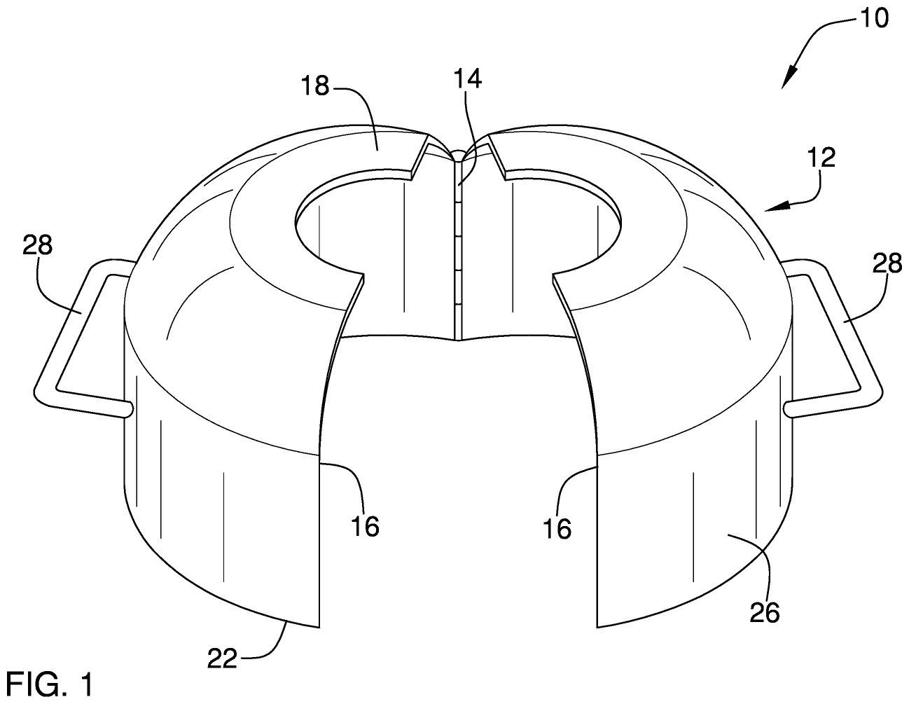

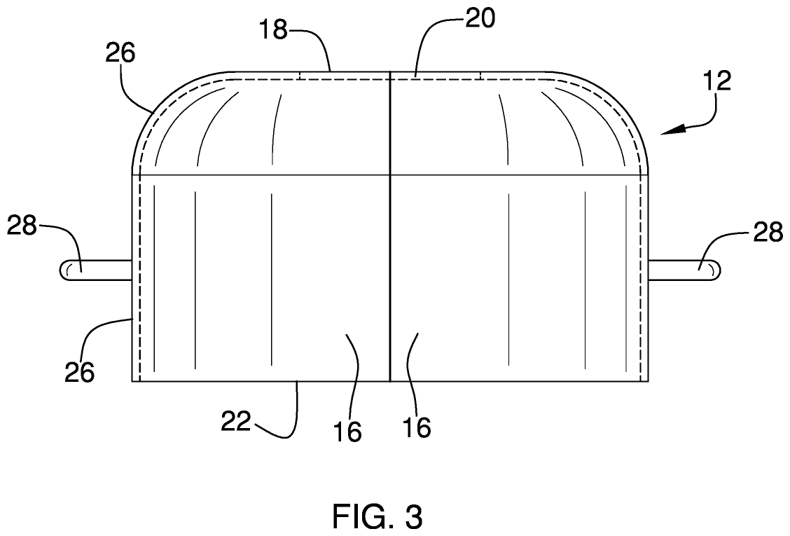

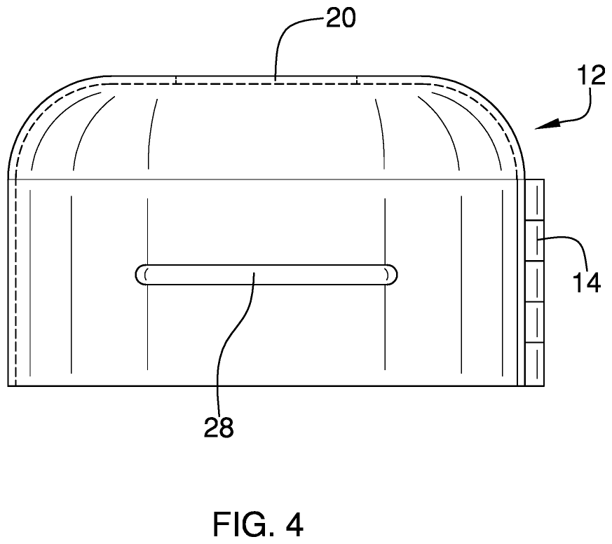

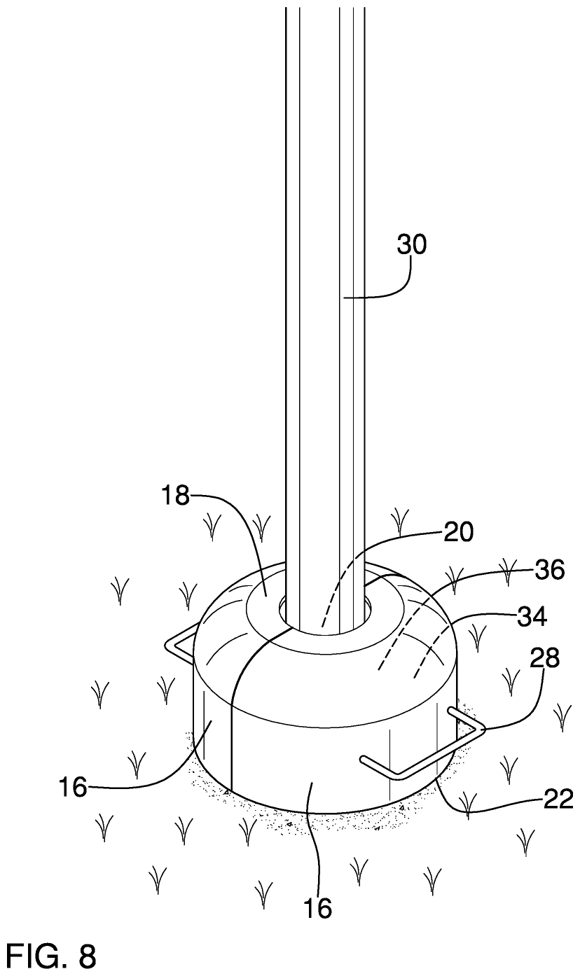

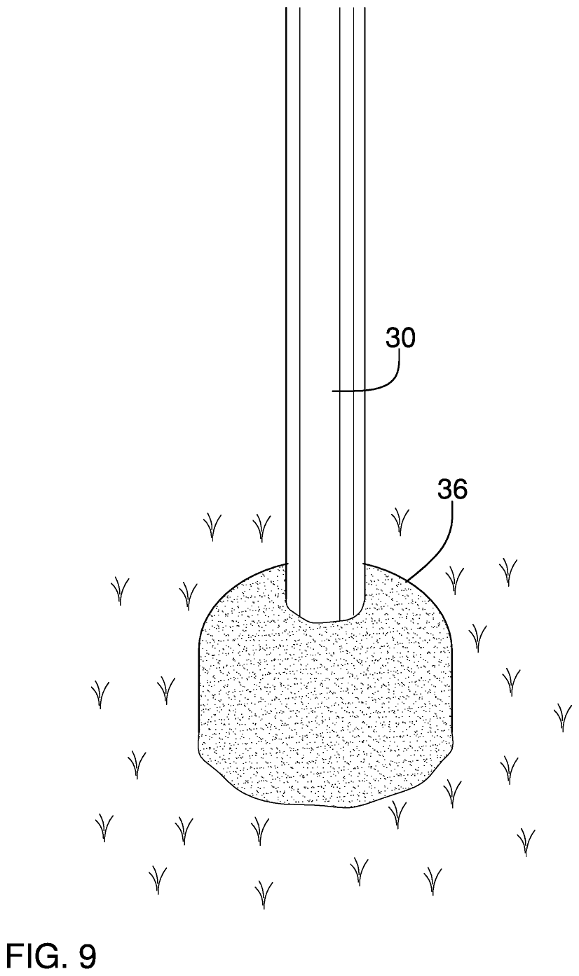

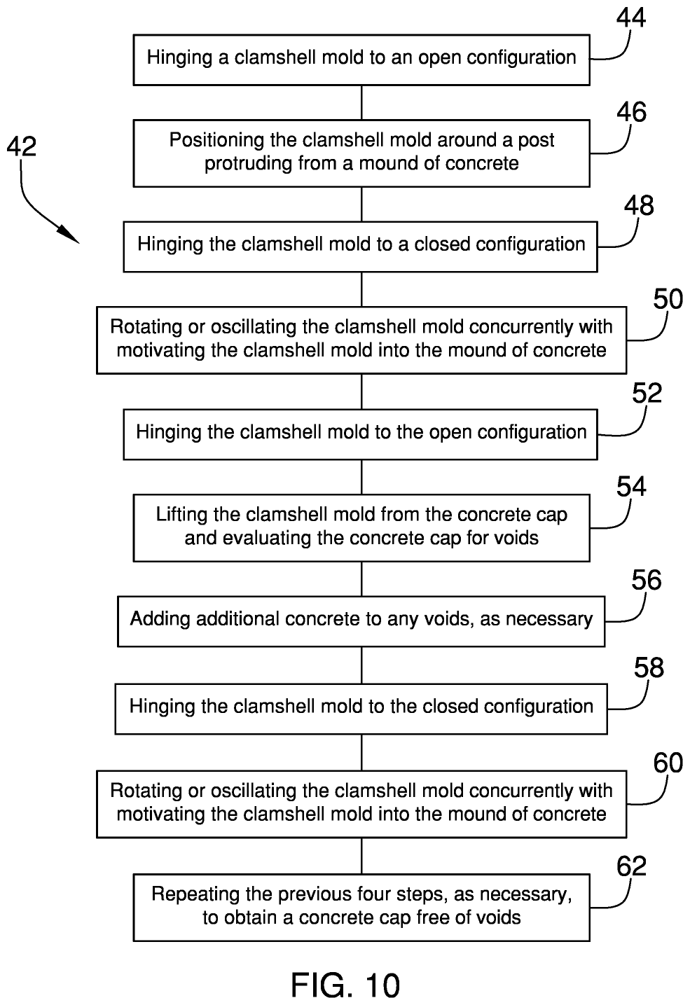

With reference now to the drawings, and in particular to FIGS. 1 through 10 thereof, a new concrete mold embodying the principles and concepts of an embodiment of the disclosure and generally designated by the reference numeral 10 will be described.

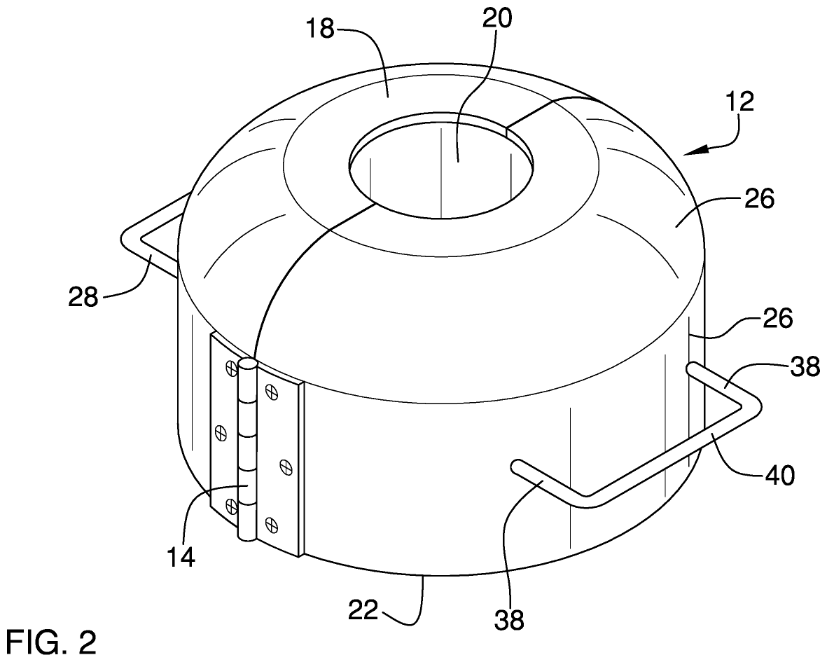

As best illustrated in FIGS. 1 through 10, the concrete cap molding device 10 generally comprises a clamshell mold 12, which is selectively hingable between an open configuration and a closed configuration, as shown in FIGS. 1 and 2 respectively, by means of a hinge 14. The hinge 14 is attached to and extends between a pair of elements 16 that defines the clamshell mold 12. The clamshell mold 12 in the closed configuration comprises a top 18 and defines an orifice 20 in the top 18, which is circular and centrally positioned. A bottom 22 of the clamshell mold 12 is open. The clamshell mold 12 has a circular cross-sectional profile 24 when viewed from the bottom 22 or the top 18. A sidewall 26 extends between the top 18 and the bottom 22.

A plurality of handles 28 is attached to the pair of elements 16 so that each element 16 is fitted with at least one handle 28. Respective handles 28 are configured to be grasped in hands of a user, enabling the user to position the clamshell mold 12 around a post 30 that protrudes from a mound 32 of concrete 34 and to close the clamshell mold 12. The handles 28 also enable the user to rotate or oscillate the clamshell mold 12, concurrently with motivating the clamshell mold 12 into the mound 32 of concrete 34, to mold the mound 32 of concrete 34 into a concrete cap 36 around the post 30.

As shown in FIGS. 1-4, the plurality of handles 28 comprises two handles 28, which are attached singly to and which extend from the elements 16. The handles 28 are opposingly positioned on the clamshell mold 12 with the clamshell mold 12 positioned in the closed configuration. This positioning promotes even transfer of a downward force, which is applied to the handles 28 and the clamshell mold 12, to the mound 32 of concrete 34.

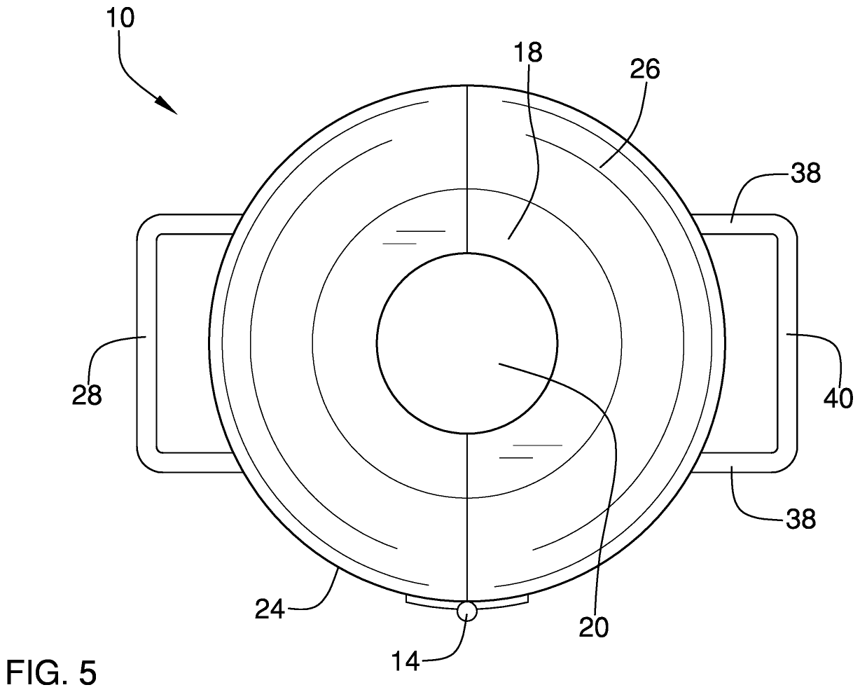

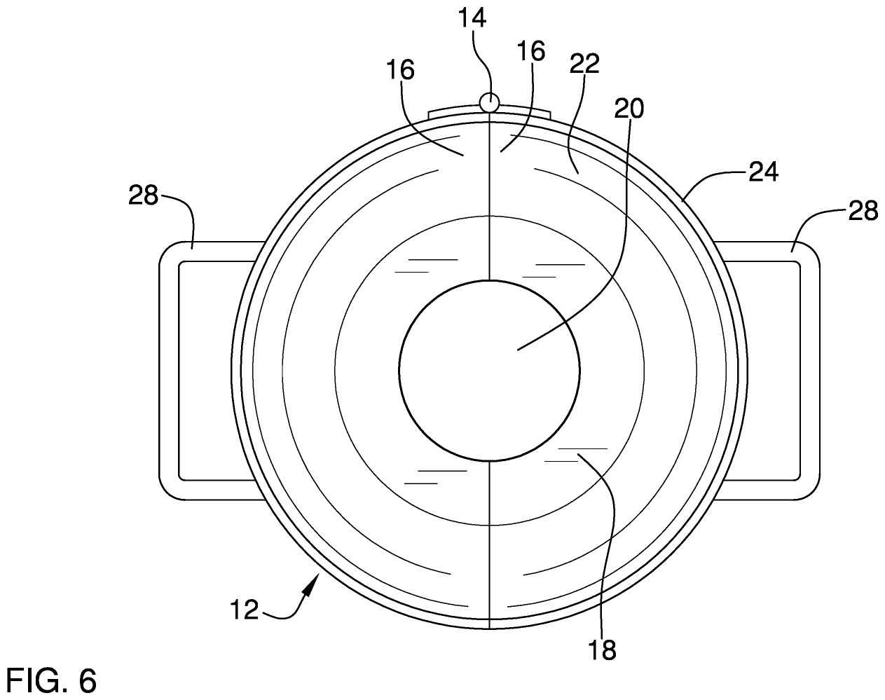

As shown in FIGS. 5 and 6, each handle 28 of the plurality of handles 28 comprises a pair of first bars 38 and a second bar 40. Each first bar 38 is attached to and extends from a respective element 16. The second bar 40 is attached to and extends between the first bars 38 distal from the respective element 16. The present invention also anticipates the plurality of handles 28 comprising other grasping means, such as, but not limited to, rods extending axially from the element 16, handles 28 as described above, but rotated 90°, or the like.

As shown in FIGS. 1-4, the sidewall 26 is arcuate proximate to the top 18 so that the clamshell mold 12 is domed in the closed configuration. The present invention anticipates the sidewall 26 being of a variety of shapes, thereby allowing molding of the concrete 34 mound 32 into a variety of shapes. For example, the sidewall 26 could comprise one or more of annular convex sections, annular concave sections, annular groves, or the like. Additionally, the sidewall 26 may be circumferentially variable between the bottom 22 and the top 18. The present invention also anticipates the clamshell mold 12 being securable in the closed configuration, such as by means of a latch, strap, or the like (not shown), to retain the clamshell mold 12 in the closed configuration as the concrete 34 cures.

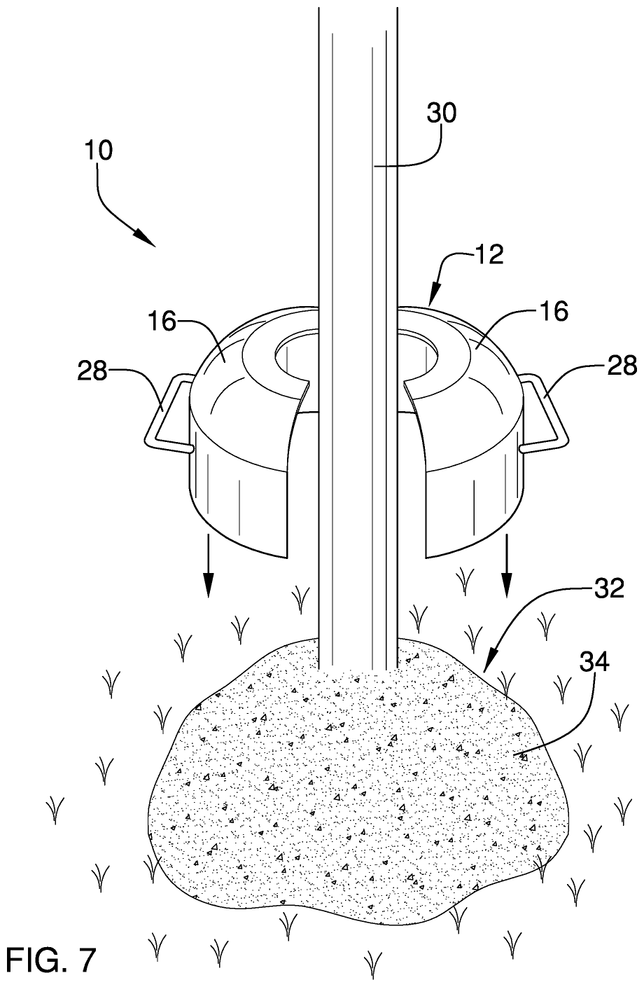

In use, the concrete cap molding device 10 enables a method of molding a concrete cap 42, as shown in FIGS. 7-9. A first step 44 of the method 42 is hinging a clamshell mold 12 to an open configuration. A second step 46 of the method 42 is positioning the clamshell mold 12 around a post 30 protruding from a mound 32 of concrete 34. A third step 48 of the method 42 is hinging the clamshell mold 12 to a closed configuration so that the post 30 protrudes through an orifice 20 centrally positioned in a top 18 of the clamshell mold 12. A fourth step 50 of the method 42 is rotating or oscillating the clamshell mold 12 concurrently with motivating the clamshell mold 12 into the mound 32 of concrete 34 so that the mound 32 of concrete 34 enters the clamshell mold 12 from a bottom 22 of the clamshell mold 12. The bottom 22 is open.

A fifth step 52 the method 42 is hinging the clamshell mold 12 to the open configuration. A sixth step 54 of the method 42 is lifting the clamshell mold 12 from the concrete cap 36 and evaluating the concrete cap 36 for voids. A seventh step 56 of the method 42 is adding additional concrete 34 to any voids, as necessary. An eighth step 58 of the method 42 is hinging the clamshell mold 12 to the closed configuration. A ninth step 60 of the method 42 is rotating or oscillating the clamshell mold 12 concurrently with motivating the clamshell mold 12 into the mound 32 of concrete 34. A tenth step 62 of the method 42 is repeating the previous four steps, as necessary, to obtain a concrete cap 36 that is free of voids.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A concrete cap molding device comprising:
a clamshell mold selectively hingable between an open configuration and a closed configuration, the clamshell mold in the closed configuration comprising:
a top, the clamshell mold in the closed configuration defining an orifice centrally positioned in the top, the orifice being circular,
a bottom, the bottom being open, the clamshell mold having a circular cross-sectional profile when viewed from the bottom or the top, and
a sidewall extending between the top and the bottom; and
a plurality of handles attached to a pair of elements defining the clamshell mold, such that each element is fitted with at least one handle, wherein respective handles of the plurality of handles are configured for grasping in hands of a user, enabling the user for positioning the clamshell mold around a post protruding from a mound of concrete, for closing the clamshell mold, and for rotating or oscillating the clamshell mold concurrently with motivating the clamshell mold into the mound of concrete for molding the mound of concrete into a concrete cap around the post.

2. The concrete cap molding device of claim 1, wherein the sidewall is arcuate proximate to the top, such that the clamshell mold in the closed configuration is domed.

3. The concrete cap molding device of claim 1, further including a hinge attached to and extending between the pair of elements.

4. The concrete cap molding device of claim 1, wherein the plurality of handles comprises two handles attached singly to and extending from the elements.

5. The concrete cap molding device of claim 4, wherein the handles are opposingly positioned on the clamshell mold with the clamshell mold positioned in the closed configuration.

6. The concrete cap molding device of claim 1, wherein each handle of the plurality of handles comprises:
a pair of first bars attached to and extending from a respective element; and
a second bar attached to and extending between the first bars of pair of first bars distal from the respective element.

7. A concrete cap molding device comprising:
a clamshell mold selectively hingable between an open configuration and a closed configuration, the clamshell mold in the closed configuration comprising:
a top, the clamshell mold in the closed configuration defining an orifice centrally positioned in the top, the orifice being circular,
a bottom, the bottom being open, the clamshell mold having a circular cross-sectional profile when viewed from the bottom or the top, and
a sidewall extending between the top and the bottom, the sidewall being arcuate proximate to the top, such that the clamshell mold in the closed configuration is domed;
a hinge attached to and extending between a pair of elements defining the clamshell mold; and
a plurality of handles attached to a pair of elements defining the clamshell mold, such that each element is fitted with at least one handle, wherein respective handles of the plurality of handles are configured for grasping in hands of a user, enabling the user for positioning the clamshell mold around a post protruding from a mound of concrete, for closing the clamshell mold, and for rotating or oscillating the clamshell mold concurrently with motivating the clamshell mold into the mound of concrete for molding the mound of concrete into a concrete cap around the post, the plurality of handles comprising two handles attached singly to and extending from the elements, the handles being opposingly positioned on the clamshell mold with the clamshell mold positioned in the closed configuration, each handle of the plurality of handles comprising:
a pair of first bars attached to and extending from a respective element, and
a second bar attached to and extending between the first bars of pair of first bars distal from the respective element.

8. A method of molding a concrete cap comprising the steps of:
hinging a clamshell mold to an open configuration;
positioning the clamshell mold around a post protruding from a mound of concrete;
hinging the clamshell mold to a closed configuration, such that the post protrudes through an orifice centrally positioned in a top of the clamshell mold;
rotating or oscillating the clamshell mold concurrently with motivating the clamshell mold into the mound of concrete, such that the mound of concrete enters the clamshell mold from a bottom of the clamshell mold, the bottom being open;
hinging the clamshell mold to the open configuration;
lifting the clamshell mold from the concrete cap and evaluating the concrete cap for voids;
adding additional concrete to any voids, as necessary;
hinging the clamshell mold to the closed configuration;
rotating or oscillating the clamshell mold concurrently with motivating the clamshell mold into the mound of concrete; and
repeating the previous four steps, as necessary, to obtain a concrete cap free of voids.

9. The method of claim 8, further including:
the orifice being circular;
the clamshell mold having a circular cross-sectional profile when viewed from the bottom or the top;
the clamshell mold comprising a sidewall extending between the top and the bottom; and
a plurality of handles attached to a pair of elements defining the clamshell mold, such that each element is fitted with at least one handle, wherein respective handles of the plurality of handles are configured for grasping in hands of a user, enabling the user for positioning the clamshell mold around the post protruding and for rotating or oscillating the clamshell mold concurrently with motivating the clamshell mold into the mound of concrete.
